(19) United States
(12) Patent Application Publication
(10) Pub. No.: US 2009/0196570 A1
(43) Pub. Date: Aug. 6, 2009

(54) SYSTEM AND METHODS FOR ONLINE COLLABORATIVE VIDEO CREATION

(75) Inventors: David A. Dudas, Encinitas, CA (US); James H. Kaskade, Encinitas, CA (US); Kenneth W. O'Flaherty, Encinitas, CA (US)

Correspondence Address: PROCOPIO, CORY, HARGREAVES & SAVITCH LLP, 530 B STREET, SUITE 2100, SAN DIEGO, CA, 92101, US

(73) Assignee: EYESOPT CORPORATION, Encinitas, CA (US)

(21) Appl. No.: 12/159,736

(22) PCT Filed: Jan. 5, 2007
(86) PCT No.: PCT/US07/60180

§ 371 Date: Jan. 29, 2009

Related U.S. Application Data
(60) Provisional application No. 60/756,392, filed on Jan. 5, 2006.

(51) Int. Cl. H04N 5/93; G06F 15/16

(52) U.S. Cl. 386/52; 709/206

(57) ABSTRACT

A system and related methods comprise an Internet-hosted application service for online storage, editing and sharing of digital video content, whereby a group of users collaborate to jointly create a video production. Three methods are outlined for use with an online editor: sequential (round-robin editing), largely parallel (editor-in-charge editing), and fully parallel (Delphi editing). The Internet-hosted application service can be used on a dedicated website or its functionality can be served to different websites seeking to provide users with enhanced video editing capabilities.

This application hereby incorporates by reference the following U.S. Non-Provisional Patent Applications.

| | | FILING |
|---|---|---|
| TITLE | APP. NO. | DATE |
| SYSTEM AND METHODS FOR STORING, EDITING, AND | | Jan. 05, 2007 |
| SHARING DIGITAL VIDEO | | |
| AUTOMATIC AGGREGATION OF CONTENT FOR USE IN | | Jan. 05, 2007 |
| AN ONLINE VIDEO EDITING SYSTEM | | |
| SYSTEM AND METHODS FOR DISTRIBUTED EDIT | | Jan. 05, 2007 |
| PROCESSING IN AN ONLINE VIDEO EDITING SYSTEM | | |

### FIELD OF THE INVENTION

This invention relates in general to the use of computer technology to store, edit and share personal digital video material, and in particular to a system and methods that enable users to collaborate in the creation of a video production.

### BACKGROUND

Collaboration in the creation of video productions has so far been the limited domain of movie and TV professionals, using expensive computer-based systems and software. None of the popular desktop video editors available to consumer videographers have the ability to support collaborative video production. If two or more amateur videographers were to attempt to collaborate, they would need to transmit large video files back and forth to each other, and would quickly run into storage and bandwidth issues, as well as potential incompatibilities between the hardware and software they use.

There are currently around 500 million devices in existence worldwide that are capable of producing video: 350 million video camera phones, 115 million video digital cameras, plus 35 million digital camcorders. The extremely rapid increase in availability of such devices, especially camera phones, has generated a mounting need on the part of consumers to find ways of converting their video material into productions that that they can share with others. This amounts mainly to a need for two capabilities: video editing and online video sharing.

Online sharing of consumer-generated video material via the Internet is a relatively new phenomenon, and is still poorly developed. A variety of websites have come into existence to support online video publishing and sharing. Most of these sites are focused on providing a viewing platform whereby members can upload their short amateur video productions to the website and offer them for viewing by the general public (or in some cases by specified users or groups of users), and whereby visitors to the website can browse and select video productions for viewing. But none of these websites currently support editing of video material, and most of them have severe limitations on the length of videos that they support (typically a maximum of 5-10 minutes). Consequently, most videos available for viewing on these sites are short (typically averaging less than 2 or 3 minutes), and are of poor quality, since they have not been edited.

Storing, editing, and sharing video is therefore difficult for consumers who create video material today on various electronic devices, including digital still cameras (“DSCs”), digital video camcorders (“DVCs”), mobile phones equipped with video cameras and computer mounted web cameras (“webcams”). These devices create video files of varying sizes, resolutions and formats. Digital video recorders (“DVRs”), in particular, are capable of recording several hours of high-resolution material occupying multiple gigabytes of digital storage. Consumers who generate these video files typically wish to edit their material down to the highlights that they wish to keep, save the resulting edited material on some permanent storage medium, and then share this material with friends and family, or possibly with the public at large.

A wide variety of devices exist for viewing video material, ranging from DVD players, TV-connected digital set-top boxes (“DSTBs”) and DVRs, mobile phones, personal computers (“PCs”), and video viewing devices that download material via the PC, such as handheld devices (e.g., PalmOne), or the Apple video iPod. The video recording formats accepted by each of these viewing devices vary widely, and it is unlikely that the format that a particular delivery device accepts will match the format in which a particular video production will have been recorded.

FIG. 1 is a block diagram illustrating a prior art video editing platform including a creation block 199, a consumption block 198, and a media aggregation, storage, manipulation & delivery infrastructure 108. FIG. 1 shows with arrows the paths that currently exist for transferring video material from a particular source, including a DSC 100, a DVC 102, a mobile phone 104, and a webcam 106 to a particular destination viewing device including a DVD player 110, a DSTB 112, a DVR 114, a mobile phone 116, a handheld 118, a video iPod 120, or a PC 122. The only destination device that supports material from all input devices is the PC 122. Otherwise, mobile phone 104 can send video material to another mobile phone 116, and a limited number of today's digital camcorders and digital cameras can create video material on DVDs that can then be viewed on the DVD player 110. In general, these paths are fractured and many of the devices in the creation block 199 have no way of interfacing with many of the devices in the consumption block 198. Beyond the highlighted paths through the media aggregation, storage, manipulation & delivery infrastructure 108, no other practical video transfer paths exist today.

Moreover, one further need has emerged: the need for consumers to collaborate in creating video productions. For example, several guests at a wedding reception may take video footage at the event. The wedding party and many of the attendees would like to have a compendium of the best footage taken by these guests, yet there is no practical way to achieve this.

There is thus a need to provide consumers with an online service that facilitates the support for collaboration in producing video and eliminates many of the drawbacks associated with current schemes.

### SUMMARY

A system and methods are disclosed for storing, editing and distributing video material in an online environment. A system and related methods comprise an Internet-hosted application service for online storage, editing and sharing of digital video content, whereby a group of users collaborate to jointly create a video production. Three methods are outlined for use in an online editor: sequential (round-robin editing), largely parallel (editor-in-charge editing), and fully parallel (Delphi editing).

With round-robin editing, a group project is defined, with a sequential list of contributors, and each contributor in turn adds video material into the production, until the last contributor is finished. With editor-in-charge editing, all contributors submit their video material, and one person designated as editor is responsible for selecting the best material from each contributor and building the video production. With Delphi editing, all contributors submit their video material, and then all contributors create their own amalgamated version, borrowing from the other contributors' materials; in successive editing rounds, all contributors examine all of the latest versions and re-edit their production to again borrow from their collaborators, until convergence occurs.

In all cases, the online editor provides facilities supporting the collaborative development, including check-in and check-out procedures for video material and work-in-progress, notification of required actions by collaborators, tracking of completion of actions, ability to provide information as to users who are currently engaged in editing, notification of project completion, and a “hyper-template” facility for sharing of video creation processes.

The Internet-hosted application service can be used on a dedicated website or its functionality can be served to different websites seeking to provide users with enhanced video editing capabilities. Although three collaborative editing schemes are described with specificity, any number of collaborative schemes can be used. In particular an online video platform as is currently described allows for the application of any collaborative video editing process or algorithm to be implemented in such as way that does not constrain the editors by geographical location, by having to send component files or works-in-progress to each other, or by having to work across multiple editing platforms on their desktop. Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram illustrating a prior art video editing platform.

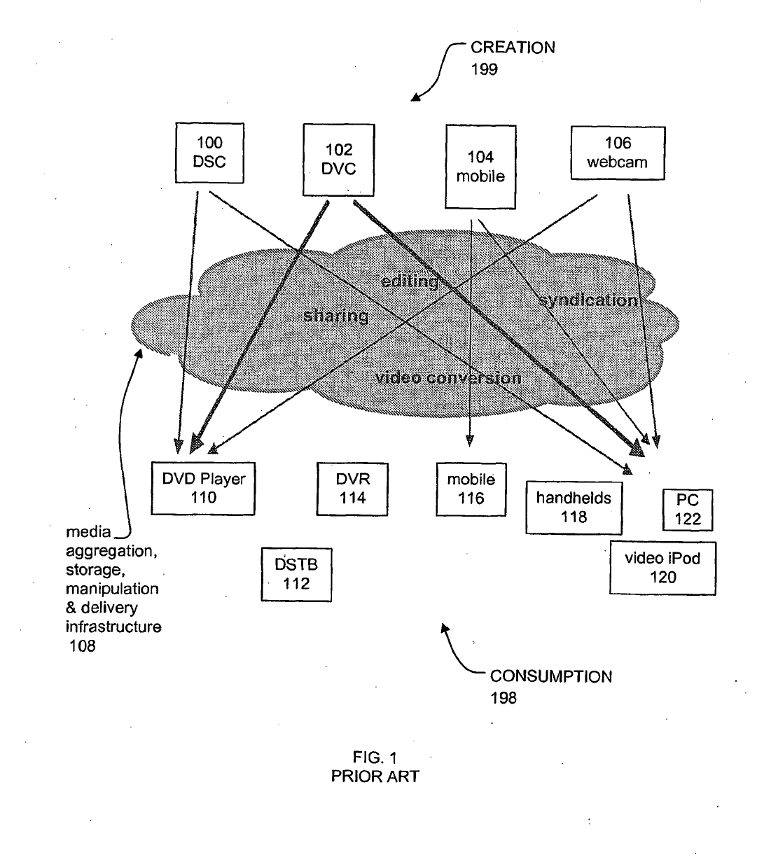

FIG. 2 is a block diagram illustrating the functional blocks or modules in an example architecture.

FIG. 3 is a block diagram illustrating an example online video platform.

FIG. 4 is a block diagram illustrating an example online video editor application.

FIG. 5 is a block diagram illustrating an example video preprocessing application.

FIG. 6 is a diagram illustrating an example process for sequential round robin editing.

FIG. 7 is a diagram illustrating an example process for sequential round robin editing including a timeout mechanism.

FIG. 8 is a diagram illustrating an example process for editor-in-charge editing.

FIG. 9 is a diagram illustrating an example process for Delphi editing.

### DETAILED DESCRIPTION

Certain examples as disclosed herein provide for the use of computer technology to store, edit, and share personal digital video material. In one aspect, a system and related methods is provided that comprise an Internet-hosted application service for online storage, editing and sharing of digital video content, whereby a group of users collaborate to jointly create a video production. Three methods are outlined for use with an online editor: sequential (round-robin editing), largely parallel (editor-in-charge editing), and fully parallel (Delphi editing).

After reading this description it will become apparent to one skilled in the art how to implement the invention in various alternative examples and alternative applications. However, although various examples of the present invention are described herein, it is understood that these examples are presented by way of example only, and not limitation. As such, this detailed description of various alternative examples should not be construed to limit the scope or breadth of the present invention as set forth in the appended claims.

Those of skill will further appreciate that the various illustrative logical blocks, modules, circuits, and algorithm steps described in connection with the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be inte rpreted as causing a departure from the scope of the invention. In addition, the grouping of functions within a module, block, circuit or step is for ease of description. Specific functions or steps can be moved from one module, block or circuit without departing from the invention.

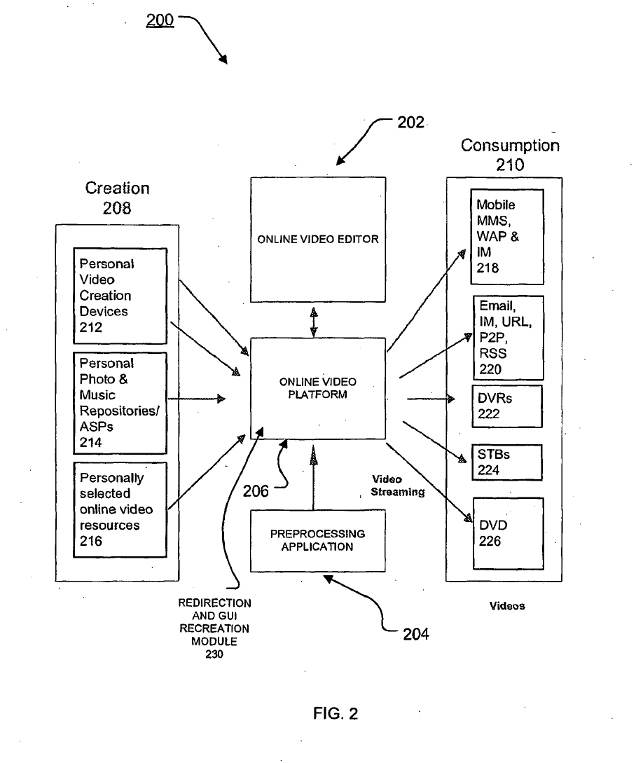

Referring now to the Figures, FIG. 2 is a block diagram illustrating the functional blocks or modules in an example architecture. In the illustrated example, a system 200 includes an online video platform 206, an online video editor 202, a preprocessing application 204, as well as a content creation block 208 and a content consumption block 210.

The content creation block 208 may include input data from multiple sources that are provided to the online video platform 206, including personal video creation devices 212, personal photo and music repositories 214, and personally selected online video resources 216, for example.

In one example, video files may be uploaded by consumers from their personal video creation devices 212. The personal video creation devices 212 may include, for example, DSCs, DVCs, cell phones equipped with video cameras, and webcams. In another example, input to the online video platform 206 may be obtained from other sources of digital video and non-video content selected by the user. Non-video sources include the personal photo and music repositories 214, which may be stored on the user's PC, or on the video server, or on an external server, such as a photo-sharing application service provider (“ASP”), for example. Additional video sources include websites that publish shareable video material, such as news organizations or other external video-sharing sites, which are designated as personally selected online video resources 216, for example.

The online video editor 202 (also referred to as the Internet-hosted application service) can be used on a dedicated website or its functionality can be served to different websites seeking to provide users with enhanced video editing capabilities. For example, a user may go to any number of external websites providing an enhanced video editing service. The present system may be used, for example, to enable the external websites to provide the video editing capabilities while maintaining the look and feel of the external websites. In that respect, the user of one of the external websites may not be aware that they are using the present system other than the fact that they are using functionality provided by the present system. In a transparent manner then, the system may serve the application to the external IP address of the external website and provide the needed function while at the same time running the application in a manner consistent with the graphical user interface (“GUI”) that is already implemented at the external IP address. Alternatively, a user of the external website may cause the invocation of a redirection and GUI recreation module 230, which may cause the user to be redirected to one of the servers used in the present system which provides the needed functionality while at the same time recreating the look and feel of the external website.

Video productions may be output by the online video platform 206 to the content consumption block 210. Content consumption block 210 may be utilized by a user of a variety of possible destination devices, including, but not limited to, mobile devices 218, computers 220, DVRs 222, DSTBs 224, and DVDs 226. The mobile devices 218 may be, for example, cell phones or PDAs equipped with video display capability. The computers 220 may include PCs, Apples, or other computers or video viewing devices that download material via the PC or Apple, such as handheld devices (e.g., PalmOne), or an Apple video iPod. The DVDs 226 may be used as a media to output video productions to a permanent storage location, as part of a fulfillment service for example.

Delivery by the online video platform 206 to the mobile devices 218 may use a variety of methods, including but not limited to a multimedia messaging service (“MMS”), a wireless application protocol (“WAP”), and instant messaging (“IM”). Delivery by the online video platform 206 to the computers 220 may use a variety of methods, including but not limited to: email, IM, uniform resource locator (“URL”) addresses, peer-to-peer file distribution (“P2P”), or really simple syndication (“RSS”), for example.

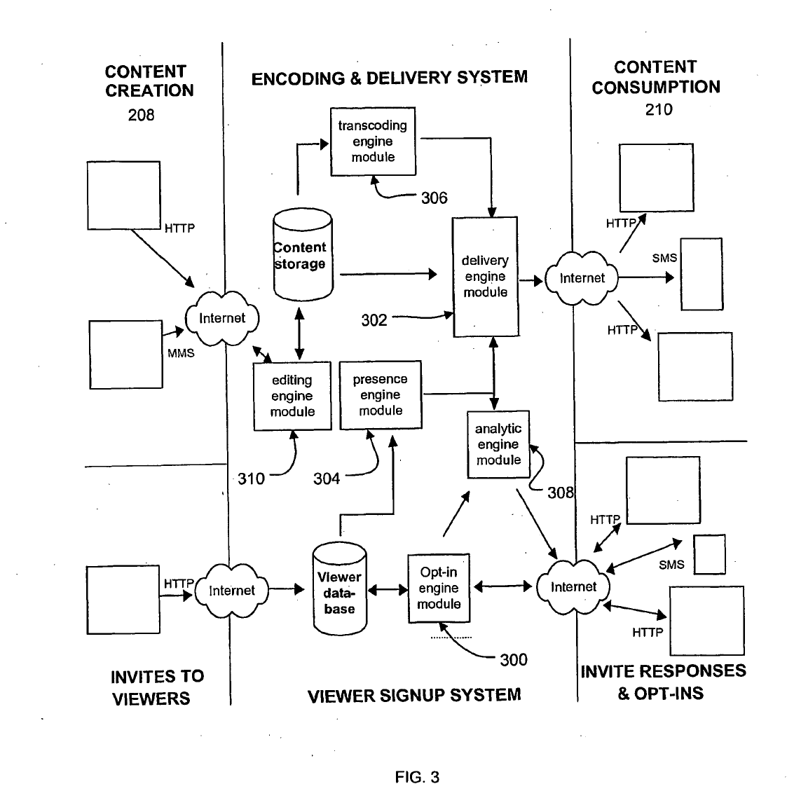

The functions and the operation of the online video platform 206 will now be described in more detail with reference to FIG. 3. FIG. 3 is a block diagram illustrating an example online video platform. In the illustrated example, the online video platform 206 includes an opt-in engine module 300, a delivery engine module 302, a presence engine module 304, a transcoding engine module 306, an analytic engine module 308, and an editing engine module 310.

The online video platform 206 may be implemented on one or more servers, for example, Linux servers. The system can leverage open source applications and an open source software development environment. The system has been architected to be extremely scalable, requiring no system reconfiguration to accommodate a growing number of service users, and to support the need for high reliability.

The application suite may be based on AJAX where the online application behaves as if it resides on the user's local computing device, rather than across the Internet on a remote computing device, such as a server. The AJAX architecture allows users to manipulate data and perform “drag and drop” operations, without the need for page refreshes or other interruptions.

The opt-in engine module 300 may be a server, which manages distribution relationships between content producers in the content creation block 208 and content consumers in the content consumption block 210. The delivery engine module 302 may be a server that manages the delivery of content from content producers in the content creation block 208 to content consumers in the content consumption block 210. The presence engine module 304 may be a server that determines device priority for delivery of content to each consumer, based on predefined delivery preferences and detection of consumer presence at each delivery device.

The transcoding engine module 306 may be a server that performs decoding and encoding tasks on media to achieve optimal format for delivery to target devices. The analytic engine module 308 may be a server that maintains and analyzes statistical data relating to website activity and viewer behavior. The editing engine module 310 may be a server that performs tasks associated with enabling a user to edit productions efficiently in an online environment.

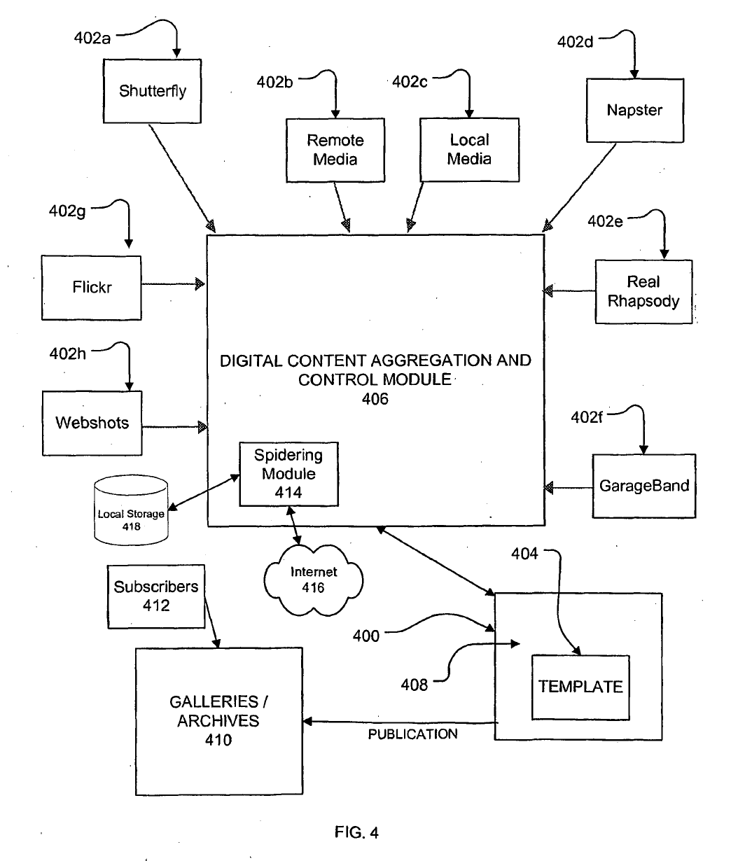

The functions and the operation of the online video editor 202 will now be described in more detail with reference to FIG. 4. FIG. 4 is a block diagram illustrating an example online video editor 202. In the illustrated example, the online video editor 202 includes an interface 400, input media 402a-h, and a template 404. A digital content aggregation and control module 406 may also be used in conjunction with the online video editor 202 and thumbnails 408 representing the actual video files may be included in the interface 400.

The online video editor 202 may be an Internet-hosted application, which provides, the interface 400 for selecting video and other digital material (e.g., music, voice, photos) and incorporating the selected materials into a video production via the digital content aggregation and control module 406. The digital content aggregation and control module 406 may be software, hardware, and/or firmware that enables the modification of the video production as well as the visual representation of the user's actions in the interface 400. The input media 402a-h may include such input sources as the shutterfly website 402a, remote media 402b, local media 402c, the napster web service 402d, the real rhapsody website 402e, the garage band website 402f, the flicker website 402g and webshots 402h. The input media 402a-h may be media that the user has selected for possible inclusion in the video production and may be represented as the thumbnails 408 in a working “palette” of available material elements, in the main window of the interface 400. The input media 402a-h may be of diverse types and formats, which may be aggregated together by the digital content aggregation and control module 406.

The thumbnails 408 are used as a way to represent material and can be acted on in parallel with the upload process. The thumbnails 408 may be generated in a number of manners. For example, the thumbnails may be single still frames created from certain sections within the video, clip, or mix. Alternatively, the thumbnails 408 may include multiple selections of frames (e.g., a quadrant of four frames). In another example, the thumbnails may include an actual sample of the video in seconds (e.g., a 1 minute video could be represented by the first 5 seconds). In yet another example, the thumbnails 408 can be multiple samples of video (e.g., 4 thumbnails of 3 second videos for a total of 12 seconds). In general, the thumbnails 408 are a method of representing the media to be uploaded (and after it is uploaded), whereby the process of creating the representation and uploading it takes a significantly less amount of time than either uploading the original media or compressing and uploading the original media.

The online video editor 202 allows the user to choose (or can create) the template 404 for the video production. The template 404 may represent a timeline sequence and structure for insertion of materials into the production. The template 404 may be presented in a separate window at the bottom of the screen, and the online video editor 202 via the digital content aggregation and control module 406 may allow the user to drag and drop the thumbnails 408 (representing material content) in order to insert them into the timeline to create the new video production. The online video editor 202 may also allow the user to select from a library of special effects to create transitions between scenes in the video. The work-in-progress of a particular video project may be shown in a separate window.

A spidering module 414 is included in the digital content aggregation and control module 406. The spidering module may periodically search and index both local content and external content. For example, the spidering module 414 may use the Internet 416 to search for external material periodically for inclusion or aggregation with the production the user is editing. Similarly, the local storage 418 may be a local source for the spidering module 414 to periodically spider to find additional internal locations of interest and/or local material for possible aggregation.

On completion of the project, the online video editor 202 allows the user to publish the video to one or more previously defined galleries/archives 410. Any new video published to the gallery/archive 410 can be made available automatically to all subscribers 412 to the gallery. Alternatively, the user may choose to keep certain productions private or to only share the productions with certain users.

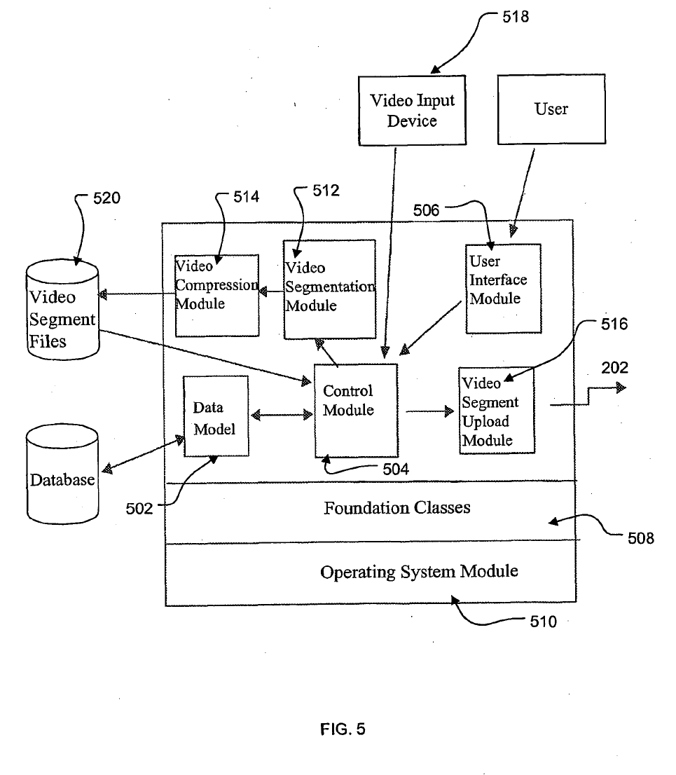

The functions and the operation of the preprocessing application 204 will now be described in more detail with reference to FIG. 5. FIG. 5 is a block diagram illustrating an example preprocessing application. In the illustrated example, the preprocessing application 204 includes a data model module 502, a control module 504, a user interface module 506, foundation classes 508, an operating system module 510, a video segmentation module 512, a video compression module 514, a video segment upload module 516, a video source 518, and video segment files 520.

In one example, the preprocessing application 204 is written in C++ and runs on a Windows PC, wherein the foundation classes 508 includes Microsoft foundation classes (“MFCs”). In this example, an object-oriented programming model is provided to the Windows APIs. In another example, the preprocessing application 204 is written, wherein the foundation classes 508 are in a format suitable for the operating system module 510 to be the Linux operating system. The video segment upload module 516 may be an application that uses a Model-View-Controller (“MVC”) architecture. The MVC architecture separates the data model module 502, the user interface module 506, and the control module 504 into three distinct components.

In operation, the preprocessing application 204 automatically segments, compresses, and uploads video material from the user's PC, regardless of length. The preprocessing application 204 uses the video segmentation module 512, the video compression module 514, and the video segment upload module 516 respectively to perform these tasks. The uploading method works in parallel with the online video editor 202, allowing the user to begin editing the material immediately, while the material is in the process of being uploaded. The material may be uploaded to the online video platform 206 and stored as one or more video segment files 520, one file per segment, for example.

The video source 518 may be a digital video camcorder or other video source device. In one example, the preprocessing application 204 starts automatically when the video source 518 is plugged into the user's PC. Thereafter, it may automatically segment the video stream by scene transition using the video segmentation module 512, and save each of the video segment files 520 as a separate file on the PC.

From the user's perspective, a video would be captured on any number of devices at the video source block 518. Once the user captured the video (i.e., on their camcorder, cellular phone, etc.) it would be transferred to a local computing device, such as the hard drive of a client computer with Internet access.

Alternatively videos can be transferred to a local computing device whereby an intelligent uploader can be deployed. In some cases, the video can be sent directly from the video source block 518 over a wireless network (not shown), then over the Internet, and finally to the online video platform 206. This alternative bypasses the need to involve a local computing device or a client computer. However, this example is most useful when the video, clip, or mix is either very short, or highly compressed, or both.

In the case that the video is not compressed or long or both, and, therefore, relatively large, it is typically transferred first to a client computer where an intelligent uploader is useful. In this example, an upload process is initiated from a local computing device using the video segment upload module 516, which facilitates the input of lengthy video material. To that end, the user would be provided with the ability to interact with the user interface module 506. Based on user input, the control module 504 controls the video segmentation module 512 and the video compression module 514, wherein the video material is segmented and compressed into the video segment files 520. For example, a lengthy production may be segmented into 100 upload segments, which are in turn compressed into 100 segmented and compressed upload segments.

Each of the compressed video segment files 520 begin to be uploaded separately via the video segment upload module 516 under the direction of the control module 504. This may occur, for example, by each of the upload segments being uploaded in parallel. Alternatively each of the upload segments may be uploaded in order, the largest segment first, the smallest segment first, or any other manner.

As the video material is being uploaded, the online video editor 202 is presented to the user. Through a user interface provided by the user interface module 506, thumbnails representing the video segments in the process of being uploaded are made available to the user. The user would proceed to edit the video material via an interaction with the thumbnails. For example, the user may be provided with the ability to drag and drop the thumbnails into and out of a timeline or a storyline, to modify the order of the segments that will appear in the final edited video material.

The system is configured to behave as if all of the video represented by the thumbnails is currently in one location (i.e., on the user's local computer) despite the fact that the material is still in the process of being uploaded by the video segment upload module 516. When the user performs an editing action on the thumbnails, for example, by dragging one of the thumbnails into a storyline, the upload process may be changed. For example, if the upload process was uploading all of the compressed upload segments in sequential order and the user dropped an upload segment representing the last sequential portion of the production into the storyline, the upload process may immediately begin to upload the last sequential portion of the production, thereby lowering the priority of the segments that were currently being uploaded prior to the user's editing action.

All of the user's editing actions are saved by the online video editor 202. Once the material is uploaded completely (including the prioritized upload segments and the remaining upload segments), the saved editing actions are applied to the completely uploaded segments. In this manner, the user may have already finished the editing process and logged off or the user may still be logged on. Regardless, the process of applying the edits only when the material is finished uploading saves the user from having to wait for the upload process to finish before editing the material. Once the final edits are applied, various capabilities exist to share, forward, publish, browse, and otherwise use the uploaded video in a number of ways.

The online video editor 202 provides methods that enable users to collaborate in the creation of a video production. Three different methods are provided in various aspects, which include: sequential round-robin editing, editor-in-charge editing, and parallel Delphi editing. Although these three collaborative editing schemes are described with specificity, any number of collaborative schemes can be used. In particular an online video platform as is currently described allows for the application of any collaborative video editing process or algorithm to be implemented in such as way that does not constrain the editors by geographical location, by having to send component files or works-in-progress to each other, or by having to work across multiple editing platforms on their desktop.

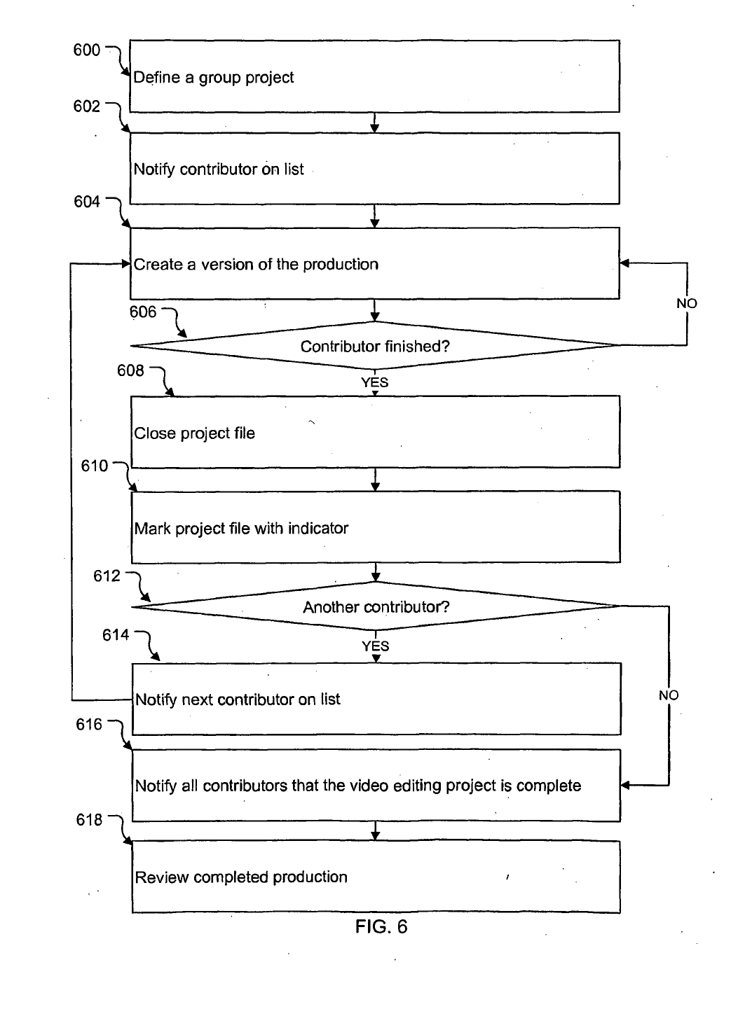

Round-robin editing is a sequential form of collaborative editing. FIG. 6 is a diagram illustrating an example process for sequential round robin editing. This process can be carried out by the online video editor 202 previously described with respect to FIG. 2. In the illustrated example, a group project is defined at step 600, together with a list of contributors to the project, and a template to be used in the project. The first contributor on the list is notified at step 602 that it is his or her turn to contribute. Notifications can be delivered by various means, including email, Instant Messaging, and cell phone text messages, for example. The first contributor creates the first version of the production at step 604, for example by opening the group project file and selecting and adding his or her video material into the timeline defined by the project template, together with other selected material, such as photos, audio, music, animation, or other video available, for example, through the system's aggregation method.

At step 606, it is determined whether the first contributor is finished. If the first contributor is not finished, the process repeats at step 604. When the first contributor has finished, he or she closes the project file at step 608. The system detects the opening and closing of project files. When the group project file is closed, the system marks the project file with an indicator showing that the contributor has finished at step 610.

At step 612, it is determined whether there is another user. If not, group editing is complete and flow proceeds to step 616. If there is another user, the system notifies the next person on the list that it is his or her turn to contribute at step 614. This person repeats the actions of the earlier contributor at step 604, namely opening the project file and adding his or her own video selections and possibly other material into the timeline defined by the project template, and then closing the project file.

The system works its way through the list of contributors, notifies the each person in turn to contribute to the video production, until the last contributor is finished. At this point, the system notifies all contributors that the video collaboration project is complete at step 616. The contributors can then review the completed production at step 618, and optionally refine the production by initiating a new group project, where the current production is used as the group template for further collaborative work.

At any time, a contributor can decide to not contribute to the project, both on the first iteration and on any further iterations. The contributor indicates this by opening and closing the project file, or by one of several possible alternative methods.

In one embodiment, in order to ensure timely completion of a collaborative editing project, the system provides a timeout mechanism, whereby a time limit can be set both for individual contributions and for the complete project. At a point-in-time before expiration of an individual timeout (e.g., one hour), the contributor is notified of the impending timeout. If an individual contributor timeout expires, the system arbitrarily closes the project file and moves on to the next contributor. At a point-in-time prior to a project timeout (e.g., one day), all contributors are notified of the impending timeout. If a project timeout expires, the system arbitrarily closes the project file and notifies all contributors that the video collaboration project is complete.

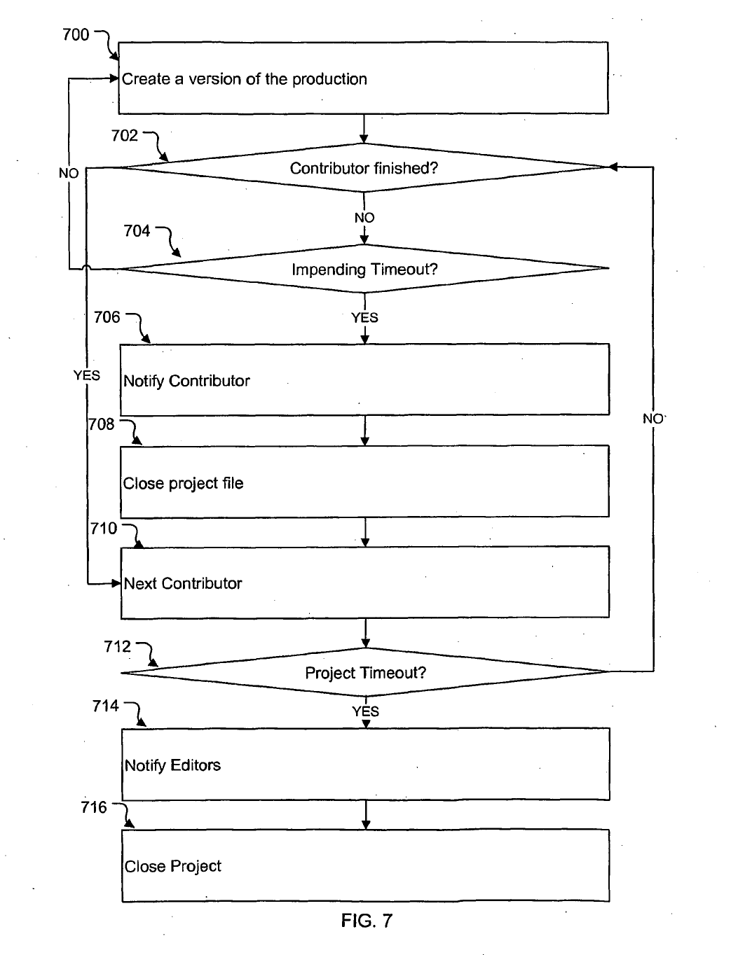

FIG. 7 is a diagram illustrating an example process for sequential round robin editing including a timeout mechanism. This process can be carried out by the online video editor 202 previously described with respect to FIG. 2. In the illustrated example, the first contributor creates the first version of the production at step 700, for example by opening the group project file and selecting and adding his or her video material into the timeline defined by the project template, together with other selected material, such as photos, audio, music, animation, or other video available, for example, through the system's aggregation method.

At step 702, it is determined whether the first contributor is finished. If the first contributor is finished, the next contributor begins editing at step 710. Otherwise, it is determined at step 704 whether there is an impending timeout. For example, the system may determine that the current user has had the project open for almost one hour and that a timeout should occur after one hour. If there is not an impending timeout, step 700 repeats and the user can continue editing. When the timeout is close to occurring, the user is notified at step 706 and then the project is closed at step 708 when the timeout period ends. Thereafter, the next contributor joins the group editing session at step 710.

At step 712, the system determines whether a project timeout has occurred. For example, the project may be set be timed out as a group editing session after one day. If one day has not passed, the process repeats with the new editor at step 700. If the project times out, all of the contributors are notified at step 714 and the project file is closed at step 716.

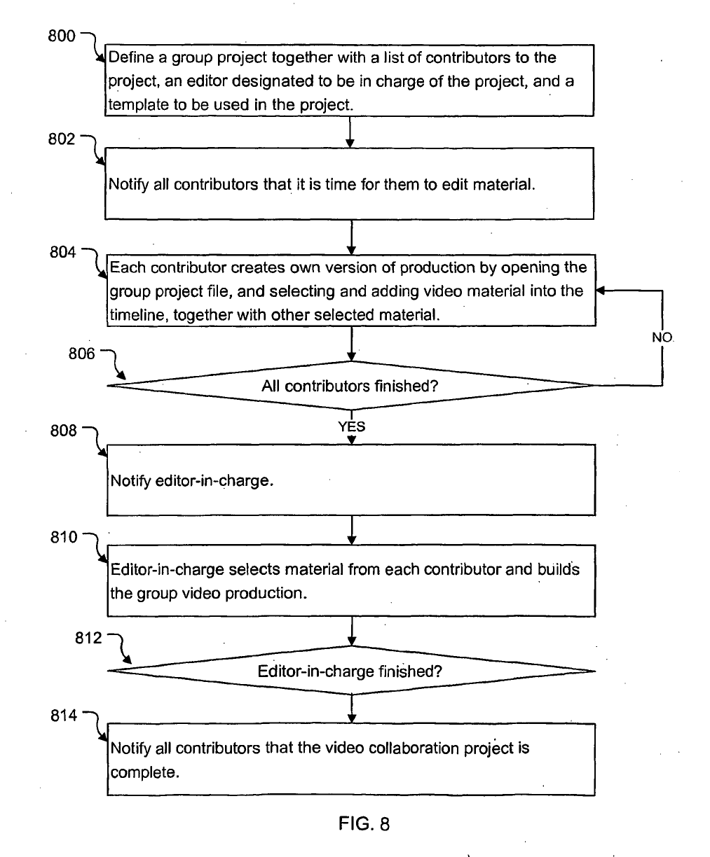

Editor-in-charge editing is a parallel form of collaborative editing, with a sequential final stage. FIG. 8 is a diagram illustrating an example process for editor-in-charge editing. This process can be carried out by the online video editor 202 previously described with respect to FIG. 2. In the illustrated example, a group project is first defined at step 800, together with a list of contributors to the project, an editor designated to be in charge of the project, and a template to be used in the project. All contributors on the list are then notified at step 802 that it is time for them to contribute their material. In one aspect, each contributor creates his or her version of the production at step 804, for example, by opening the group project file, and selecting and adding his or her video material into the timeline defined by the project template, together with other selected material, such as photos, audio, music, animation, or other video available through the system's aggregation method. In one aspect, each contributor sends just his or her own video material for inclusion in the project

At step 806, the system determines whether all of the contributors are finished. If not, the process repeats at step 804 and the group editing continues. When all members of the project have completed their contribution, the editor-in-charge is notified at step 808. The editor-in-charge then selects material from each contributor and builds the group video production at step 810. It is the responsibility of the editor-in-charge to judge the quality and relevance of each contributor's material, and determine what content should be included.

At step 812, the system determines whether the editor-in-charge is finished editing. If not, the process repeats at step 810. When the editor-in-charge has completed editing the group production, the system notifies all contributors that the video collaboration project is complete at step 814. In one aspect, all of the contributors can then review the completed production. The group can elect to refine the production by initiating a new group project, where the current production is used as the group template for further collaborative work. The follow-on project can be in any form: sequential round-robin editing, editor-in-charge editing, and parallel Delphi editing. In some cases, it may prove beneficial to follow an editor-in-charge project with a round-robin project to improve the production.

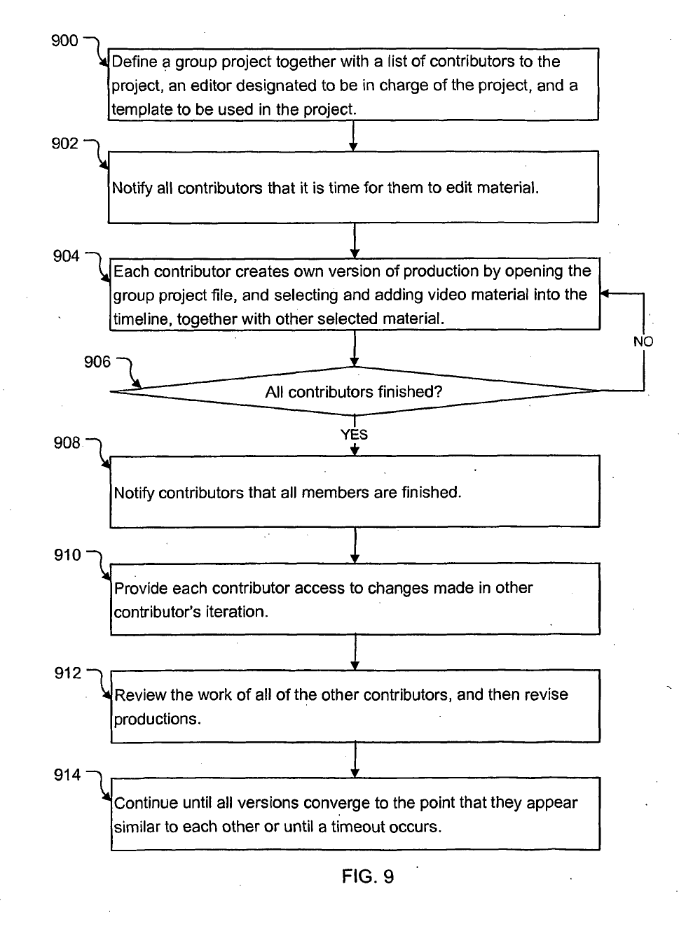

Delphi editing is a fully parallel form of collaborative editing. The Delphi method is a method for structuring a group communication process to achieve consensus, by means of iterative communication among the group; while typically applied to difficult forecasting problems, it is also sometimes used in collaborative design projects. FIG. 9 is a diagram illustrating an example process for Delphi editing. This process can be carried out by the online video editor 202 previously described with respect to FIG. 2.

In the illustrated example, all contributors successively improve their own version of the video production, based on viewing the productions of all other group members, and borrowing freely from them, until a point of convergence or near-convergence occurs. First, a group project is defined at step 900, together with a list of contributors to the project, and a template to be used in the project. All contributors on the list are then notified at step 902 that it is time for them to contribute their material. Each contributor creates his or her initial version of the production at step 904, by opening the group project file, and selecting and adding his or her video material into the timeline defined by the project template, together with other selected material, such as photos, audio, music, animation, or other video available through the system's aggregation method.

At step 906, it is determined whether the contributors have finished the current iteration (in this case the first iteration). If not, step 904 repeats. If the contributors are finished, they are notified at step 908 and provided access to each of the other contributor's iteration at step 910. Each contributor reviews the work of all of the other contributors, and then revises his or her production at step 912, with the express purpose of including what he or she considers worthwhile material from each contributor (thereby acting in a similar role to that of an editor-in-charge).

When all contributors have completed their next iteration, they again may be notified and provided access to each contributor's latest iteration. Each contributor again reviews the work of all of the other contributors, and then may revise his or her production, again borrowing from the work of the others. The next iteration is then initiated. Iterations may continue at step 914 either until all versions converge to the point that they appear similar to each other, or until a timeout occurs.

Various techniques can be applied to determine if sufficient convergence has been achieved. In one aspect, each team member votes at the end of each iteration, as to whether to stop at that point, and optionally each member votes on which is the best version. (Note that, with the Delphi method, it may not be necessary to select just one “winning” version; each team member may decide individually which version he or she may wish to use going forward.)

The online video editor provides several important support services for all of the methods of online collaborative video creation. These include check-in and check-out procedures for video material and work-in-progress, control of the group project file, and notification procedures for the following: required actions by collaborators; completion of actions; status of the project file (available for use, or in use by specific team member); timeouts pending; and project completions. The online video editor also provides the ability to capture user behavior and media metadata in order to recommend new users and content for collaborative works.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A method for editing video material comprising:
receiving video material on a remote computing device from a local computing device via an upload process;
receiving one or more editing actions performed by a group of users on the video material on the remote computing device as the upload process is occurring, the step of receiving comprising, opening of a project associated with the video material, receiving a first of the editing actions on the video material from a first user from the group of users, closing the project for the first user, and notifying a second user from the group of users that the project is closed for the first user;
saving the editing actions on the remote computing device as the upload process is occurring; and
applying the editing actions to the video material on the remote computing device once the upload process has completed.

2. The method of claim 1 wherein the step of receiving one or more editing actions further comprises using a timeout period to automatically close the project if the editing actions of the first user are not complete after the passing of a time period.

3. The method of claim 1 wherein the editing actions include adding the video material into a timeline defined by a project template.

4. The method of claim 1 wherein the editing actions include adding a photo, an audio clip, music clip, an animation, or another video.

5. The method of claim 1 wherein the step of opening of a project further comprises obtaining a template associated with the project.

6. The method of claim 1 wherein the step of opening of a project further comprises notifying the first user that the project is being open.

7. The method of claim 6 wherein the step of notifying includes one or more of sending an email, sending an instant message, and sending a cell phone text message.

8. The method of claim 1 wherein the step of closing the project further comprises marking the project file with an indicator.

9. The method of claim 1 wherein the step of closing the project further comprises detecting the closing of the project file.

10. A method for editing video material comprising:
receiving video material on a remote computing device from a local computing device via an upload process;
receiving one or more editing actions to the video material on the remote computing device by a group of users as the upload process is occurring, the step of receiving comprising, opening of a project associated with the video material, performing the editing actions on the video material in parallel by one or more members of the group of users, notifying an editor-in-charge from the group of users that the one or more members are finished performing the editing actions, and receiving one or more additional editing actions on the video material from the editor-in-charge,
saving the editing actions on the remote computing device as the upload process is occurring; and
applying the editing actions to the video material on the remote computing device once the upload process has completed.

11. The method of claim 10 wherein the step of receiving one or more additional editing actions on the video material from the editor-in-charge, further comprises selecting a portion of the editing actions that were performed in parallel by the one or more members.

12. The method of claim 11 wherein the step of receiving one or more additional editing actions on the video material from the editor-in-charge further comprises building a group video production from the selected portions of the editing actions that were performed in parallel by the one or more members.

13. The method of claim 10 wherein the editing actions include adding the video material into a timeline defined by a project template.

14. The method of claim 10 wherein the editing actions include adding a photo, an audio dip, music clip, an animation, or another video.

15. The method of claim 10 further comprising notifying the group of users that the editing actions are complete.

16. The method of claim 10 further comprising designating one of the members from the group of users to be the editor-in-charge.

17. The method of claim 10 wherein the step of opening of a project further comprises obtaining a template associated with the project.

18. A method for editing video material comprising:
receiving video material on a remote computing device from a local computing device via an upload process;
receiving one or more editing actions to the video material on the remote computing device by a group of users as the upload process is occurring, the step of receiving comprising, opening a number of projects associated with the video material, receiving the editing actions on the video material in parallel from one or more members of the group of users, notifying the one or more members from the group of users that the one or more members are finished performing the editing actions, and determining whether there is a sufficient convergence between the number of projects;
saving the editing actions on the remote computing device as the upload process is occurring; and
applying the editing actions to the video material on the remote computing device once the upload process has completed.

19. The method of claim 18 wherein the editing actions include adding the video material into a timeline defined by a project template.

20. The method of claim 18 wherein the editing actions include adding a photo, an audio clip, music clip, an animation, or another video.

21. The method of claim 18 wherein the step of determining includes receiving a vote from the one or more members.

22. The method of claim 18 wherein the step of opening of a number of projects further comprises obtaining templates associated with the number of projects.

23. The method of claim 18 wherein the step of notifying includes one or more of sending an email, sending an instant message, and sending a cell phone text message.

24. The method of claim 1 wherein the step of receiving video material on a remote computing device from a local computing device via an upload process further comprises:
receiving a plurality of compressed segments of the video material; and
changing an order in which the upload process uploads the compressed segments based on the editing actions.

25. The method of claim 10 wherein the step of receiving video material on a
remote computing device from a local computing device via an upload process further comprises:
receiving a plurality of compressed segments of the video material; and
changing an order in which the upload process uploads the compressed segments based on the editing actions.

26. The method of claim 18 wherein the step of receiving video material on a
remote computing device from a local computing device via an upload process further comprises:
receiving a plurality of compressed segments of the video material; and
changing an order in which the upload process uploads the compressed segments based on the editing actions.
